(19) United States
(12) Patent Application Publication
(10) Pub. No.: US 2013/0176169 A1
(43) Pub. Date: Jul. 11, 2013

(54) METHOD AND APPARATUS FOR MOBILE NAVIGATION USING SMART PHONE

(71) Applicant: TRIMBLE NAVIGATION LTD., Sunnyvale, CA (US)

(72) Inventors: John Paul HARMON, Albany, OR (US); Boris G. TANKHILEVICH, Walnut Creek, CA (US)

(73) Assignee: TRIMBLE NAVIGATION LTD., Sunnyvale, CA (US)

(21) Appl. No.: 13/765,685

(22) Filed: Feb. 12, 2013

Related U.S. Application Data
(63) Continuation-in-part of application No. 12/728,220, filed on Mar. 21, 2010, now abandoned.

(51) Int. Cl. G01S 19/45

(52) U.S. Cl. CPC G01S 19/45
USPC 342/357.28

(57) ABSTRACT

A method for mobile navigation by using a smart phone is provided. The smart phone comprises: a GNSS navigation processor, a motion detector, a correlation processor, a triangulation processor, and a verified location display. The method of the present technology comprises: (A) obtaining a set of GNSS processor position fixes by using the GNSS navigation processor; (B) obtaining a set of motion-related data of the smart phone by using the motion detector; and (C) correlating the set of GNSS processor position fixes associated with the smart phone and the set of motion-related data associated with the smart phone and obtaining a set of GNSS correlation data. If the set of GNSS processor position fixes based on the set of GNSS correlation data is verified, the GNSS navigation processor is used for navigation; whereas if the set of GNSS processor position fixes based on the set of GNSS correlation data is not verified, the motion detector aided by triangulation processor is used for navigation.

This is a continuation-in-part of the U.S. patent application Ser. No. 12/728,220, filed on Mar. 21, 2010, and entitled “METHOD AND APPARATUS FOR CHARACTERIZING GNSS POSITION FIXES”.

The technology relates to the field of the mobile navigation.

### BACKGROUND

GNSS (Global Navigation Satellite System) receiver's readings sometimes, especially during startup and in poor reception conditions, yield obviously false motions. Current shortcoming of the available solutions are as follows: (i) impossible to economically (without using an expensive device that is capable of self-monitoring) understand whether a device is actually moving (as the GNSS readings indicate it is) or not; (ii) there is no algorithm that allows to disregard bogus GNSS readings.

### SUMMARY

This Summary is provided to introduce a selection of concepts that are further described below in the Detailed Description. This Summary is not intended to identify key or essential features of the claimed subject matter, nor is it intended to be used as an aid in determining the scope of the claimed subject matter.

A method for mobile navigation by using a smart phone is provided. The smart phone comprises: a GNSS navigation processor, a motion detector, a correlation processor, a triangulation processor, and a verified location display.

The method of the present technology comprises: (A) obtaining a set of GNSS processor position fixes by using the GNSS navigation processor; wherein the set of GNSS processor position fixes comprises at least two Position, Velocity, and Time (PVT) solutions taken at two consecutive time points t(i) and t(j) defining a time interval. The acceleration can be calculated by using the velocity fixes at two consecutive time points t(i) and t(j) defining the time interval.

The method of the present technology further comprises: (B) obtaining a set of motion-related data of the smart phone by using the motion detector; wherein the set of motion-related data comprises at least Acceleration and Velocity taken at two consecutive time points t(i) and t(j).

The method of the present technology further comprises: (C) correlating the set of GNSS processor position fixes associated with the smart phone and the set of motion-related data associated with the smart phone and obtaining a set of GNSS correlation data.

If the set of GNSS processor position fixes based on the set of GNSS correlation data is verified, the GNSS navigation processor is used for navigation; whereas if the set of GNSS processor position fixes based on the set of GNSS correlation data is not verified, the motion detector aided by triangulation processor is used for navigation.

### DESCRIPTION OF THE DRAWINGS

The accompanying drawings, which are incorporated in and form a part of this specification, illustrate embodiments of the technology and, together with the description, serve to explain the principles below:

FIG. 1 depicts the apparatus for mobile navigation in an embodiment of the present technology.

FIG. 2 illustrates the flow chart of the method of the present technology for mobile navigation using the apparatus of FIG. 1.

### DETAILED DESCRIPTION

Reference now is made in detail to the embodiments of the technology, examples of which are illustrated in the accompanying drawings. While the present technology will be described in conjunction with the various embodiments, it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific-details are set forth in order to provide a thorough understanding of the presented embodiments. However, it will be obvious to one of ordinary skill in the art that the presented embodiments may be practiced without these specific details. In other instances, well known methods, procedures, components, and circuits have not been described in detail as not to unnecessarily obscure aspects of the presented embodiments.

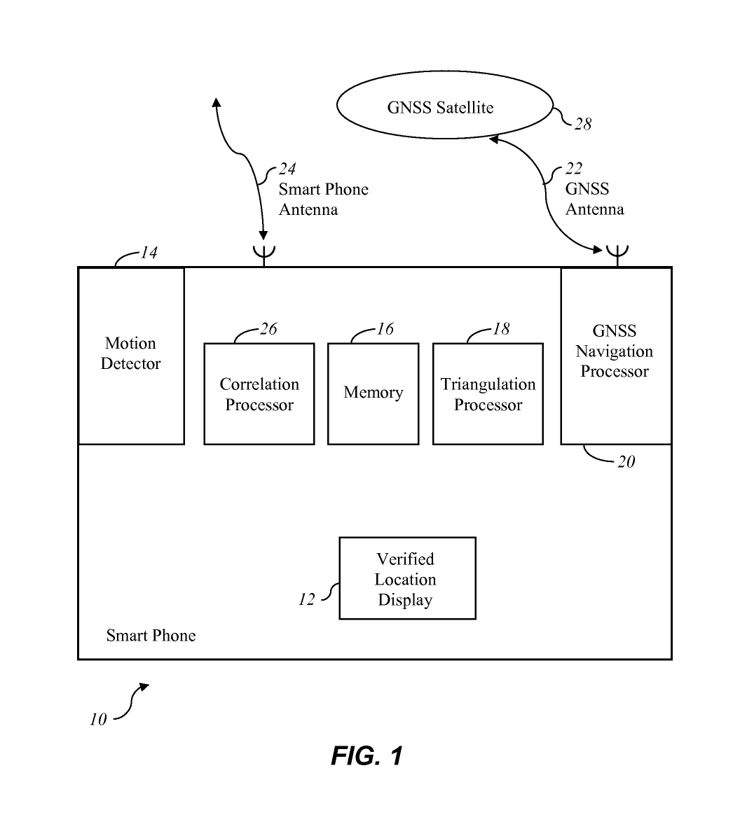

FIG. 1 depicts the apparatus 10 for mobile navigation using a smart phone in an embodiment of the present technology. The Global Navigation Satellite System (GNSS) processor 20 is configured to obtain the set of position fixes associated with the smart phone. The set of position fixes further comprises at least two Position, Velocity, and Time (PVT) solutions taken at two consecutive time points t(i) and t(j) defining a time interval. The acceleration can be calculated by using the velocity fixes at two consecutive time points t(i) and t(j) defining the time interval. In an embodiment of the present technology, the apparatus 10 comprises a smartphone including the software algorithm that enables it to perform the disclosed below method of mobile navigation. In an embodiment of the present technology, the GNSS processor 20 further comprises a transceiver (not shown), an antenna 22, and a position determination component (not shown).

In an embodiment of the present technology, the GNSS processor 20 is selected from the group consisting of: a Global Positioning System (GPS) processor; a GLONASS processor; a combined GPS/GLONASS processor; a COMPASS processor; and a GALILEO processor.

The Global Positioning System (GPS) is a system of satellite signal transmitters that transmits information from which an observer's present location and/or the time of observation can be determined. The GPS was developed by the United States Department of Defense (DOD) under its NAVSTAR satellite program. Please, see the document ICD-GPS-200: GPS Interface Control Document, ARINC Research, 1997, GPS Joint Program Office, which is incorporated by reference herein.

The second satellite-based navigation system is the Global Orbiting Navigation Satellite System (GLONASS), placed in orbit by the former Soviet Union and now maintained by the Russian Republic. The COMPASS satellite-based navigation system (also known as Beidou-2, BD2) is a project by China to develop an independent global satellite navigation system. Compass is not an extension to the previously deployed Beidou-1, but a new GNSS system similar in principle to GPS and GALILEO.

The new system will be a constellation of 35 satellites, which include 5 geostationary orbit (GEO) satellites and 30 medium Earth orbit (MEO) satellites that will offer complete coverage of the globe. The ranging signals are based on the CDMA principle and have complex structure typical to Galileo or modernized GPS. Similarly to the other GNSS, there will be two levels of positioning service: open and restricted (military). The public service shall be available globally to general users.

As disclosed in the European Commission “White Paper on European transport policy for 2010”, the European Union will develop an independent satellite navigation system GALILEO as a part of a global navigation satellite infrastructure (GNSS).

When all the currently planned GNSS systems are deployed, the users will benefit from the use of a total constellation of 75+ satellites, which will significantly improve all the aspects of positioning, especially availability of the signals in so-called “urban canyons”.

Referring still to FIG. 1, in an embodiment of the present technology, the GNSS 20 further comprises a differential GPS processor (not shown). In differential position determination, many of the errors in the RADPS signals that compromise the accuracy of absolute position determination are similar in magnitude for stations that are physically close. The effect of these errors on the accuracy of differential position determination is therefore substantially reduced by a process of partial error cancellation. Thus, the differential positioning method is far more accurate than the absolute positioning method, provided that the distances between these stations are substantially less than the distances from these stations to the satellites, which is the usual case. Differential positioning can be used to provide location coordinates and distances that are accurate to within a few centimeters in absolute terms.

The differential GPS processor can include: (a) a real time code differential GPS; (b) a post processing differential GPS; (c) a real-time kinematic (RTK) differential GPS that includes a code and carrier RTK differential GPS processor.

The differential GPS processor can obtain the differential corrections from different sources. In an embodiment of the present technology, the differential GPS processor can obtain the differential corrections from a Base Station (not shown). The fixed Base Station (BS) placed at a known location determines the range and range-rate measurement errors in each received GPS signal and communicates these measurement errors as corrections to be applied by local users. The Base Station (BS) has its own imprecise clock with the clock bias CBBASE. As a result, the local users are able to obtain more accurate navigation results relative to the Base Station location and the Base Station clock. With proper equipment, a relative accuracy of 5 meters should be possible at distances of a few hundred kilometers from the Base Station.

In an embodiment of the present technology, the differential corrections can be obtained from the Wide Area Augmentation System (WAAS) by using the wireless communication device (not shown) and the wireless communication link (not shown). The WAAS system includes a network of Base Stations that uses satellites (initially geostationary satellites-GEOs) to broadcast GPS integrity and correction data to GPS users. The WAAS provides a ranging signal that augments the GPS. Thus, the WAAS ranging signal is designed to minimize the standard GPS processor hardware modifications. The WAAS ranging signal utilizes the GPS frequency and GPS-type of modulation, including only a Coarse/Acquisition (C/A) PRN code. In addition, the code phase timing is synchronized to GPS time to provide a ranging capability. To obtain the position solution, the WAAS satellite can be used as any other GPS satellite in satellite selection algorithm. The WAAS provides the differential corrections free of charge to a WAAS-compatible user. The accuracy of this method is better than 1 meter. Referring still to FIG. 1, in an embodiment of the present technology, the GNSS processor 20 further comprises a real time kinematic (RTK) differential GPS processor (not shown) that can be used to obtain the position locations with less than 2 cm accuracy.

RTK is a process where GPS signal corrections are transmitted in real time from a reference processor at a known location to one or more remote rover processors. The use of an RTK capable GPS system can compensate for atmospheric delay, orbital errors and other variables in GPS geometry, increasing positioning accuracy up to within a centimeter. Used by engineers, topographers, surveyors and other professionals, RTK is a technique employed in applications where precision is paramount. RTK is used, not only as a precision positioning instrument, but also as a core for navigation systems or automatic machine guidance, in applications such as civil engineering and dredging. It provides advantages over other traditional positioning and tracking methods, increasing productivity and accuracy. Using the code phase of GPS signals, as well as the carrier phase, which delivers the most accurate GPS information, RTK provides differential corrections to produce the most precise GPS positioning. The RTK process begins with a preliminary ambiguity resolution. This is a crucial aspect of any kinematic system, particularly in real-time where the velocity of a rover processor should not degrade either the achievable performance or the system's overall reliability.

Referring still to FIG. 1, in an embodiment of the present technology, the differential GPS processor that can obtain the differential corrections from the Virtual Base Station (VBS) (not shown) by using the wireless communication device 23 and the wireless communication link (not shown).

Indeed, the Virtual Base Station (VBS) is configured to deliver a network-created correction data to a multiplicity of rovers via a concatenated communications link consisting of a single cellular connection, and a radio transmission or broadcasting system. The location of the radio transmitting system can be co-located with a GPS Base Station designated as the position of the local Virtual Reference Station. This GPS Base Station determines its position using GPS, and transmits its location to the VRS Base Station via a cellular link between the local GPS Base Station and the VRS Base Station. It enables the VRS Base Station to generate differential corrections as if such differential corrections were actually being generated at the real GPS Base Station location. An article “Long-Range RTK Positioning Using Virtual Reference Stations,” by Ulrich Vollath, Alois Deking, Herbert Landau, and Christian Pagels, describing VRS in more details, is incorporated herein as a reference in its entirety, and can be accessed at the following URL: http://trl.trimble.com/dscgi/ds.py/Get/File-93152/K152001-Paper-LongRange.pdf.

The Omni STAR-HP (High Performance) solution is a dual frequency GPS augmentation service that provides robust and reliable high performance GPS positioning. By using dual frequency GPS observations, Omni STAR-HP can measure the true ionospheric error at the reference station and user location, substantially eliminating this effect in positioning accuracy. Using these iono-free measurements with other information contained in the GPS processor carrier phase data, the OmniSTAR-HP solution is able to create a wide area positioning solution of unmatched accuracy and performance in selected areas. Published accuracies are 0.2 meter horizontal (Hz) and 0.3 meter vertical (Z).

Referring still to FIG. 1, in an embodiment of the present technology, the apparatus 10 further comprises a motion detector 14.

In an embodiment of the present technology, the motion detector 14 further comprises at least one accelerometer (not shown).

In an embodiment of the present technology, the motion detector 14 further comprises at least three accelerometers (not shown).

In an embodiment of the present technology, the motion detector 14 further comprises at least six accelerometers (not shown).

An accelerometer is a sensor that mathematically determines acceleration over time by measuring the speed and by using a known distance. In an embodiment of the present technology, acceleration of the apparatus 10 may be measured in each of three perpendicular directions corresponding to the x, y, and z-axes of a Cartesian coordinate system by using accelerometers. The location of the apparatus 10 can be further obtained by using a triangulation method using a triangulation correlation processor 26 and using at least three radio signals transmitted from at least three radio towers. Please, see discussion below.

In an embodiment of the present technology, accelerations of the apparatus 10 may be measured for six degrees-of-freedom by using a number of accelerometers, wherein three accelerations may be measured corresponding to the x, y, and z-axes of a Cartesian coordinate system, and wherein three additional accelerations may be measured corresponding to pitch, roll, and rotation.

For example, the motion detector 14 can be implemented by using at least one relatively inexpensive (˜$5) and having a relatively high resolution (50 micro gravities per root hertz) accelerometer based on silicon-micro machined MEMS technology. This device exploits the changes in capacitance caused by the relative movement of moving and fixed structures created in the silicon, using wafer-processing techniques.

STMicroelectronics (NYSE: STM) manufactures a MEMS-based three-axis accelerometer device LIS3L02D that provides both three-axis sensing in a single package and a digital output. This device is designed primarily for handheld terminals where it can be used to implement a motion-based user interface that is based on hand movements, allowing one-handed operation without styli, thumb keyboards or other input devices. The LIS3L02D includes a single-chip MEMS sensor chip plus a calibrated interface chip that senses changes in capacitance in the sensor and translates them into SPI or I2C serial digital outputs. The LIS3L02D operates on a 2.7 to 3.6V supply voltage. The device has an equivalent noise acceleration of better than 500 millionths of one ‘g’. During transport and service it can withstand accelerations up to 3000 g without damage.

Most micromechanical accelerometers operate in-plane, that is, they are designed to be sensitive only to a direction in the plane of the die. By integrating two devices perpendicularly on a single die a two-axis accelerometer can be made. By adding an additional out-of-plane device three axes can be measured. Such a combination may have much lower misalignment error than three discrete models combined after packaging.

Micromechanical accelerometers are available in a wide variety of measuring ranges, reaching up to thousands of g's. The designer must make a compromise between sensitivity and the maximum acceleration that can be measured.

Some smartphones, digital audio players and personal digital assistants contain accelerometers for user interface control; often the accelerometer is used to present landscape or portrait views of the device's screen, based on the way the device is being held. The 5th and 6th generation Apple iPod Nano has a built-in accelerometer in a Fitness app that can be used to record walking steps and runs.

Apple sells an accelerometer app that runs on the iPhone 3GS, iPhone 4, iPhone 4S, 3rd and 4th generation iPod Touch, and iPad. [36]

Two or three accelerometers can be mounted orthogonal to one another and can be used to measure the longitudinal acceleration axis and lateral acceleration axis. The tangential or longitudinal axis acceleration is integrated once to obtain longitudinal speed and is integrated again to produce a relative displacement. The lateral accelerometer measures the centripetal force which is used to compute a centripetal or lateral acceleration. The lateral acceleration is used to obtain a heading change derived from the lateral acceleration information and the longitudinal speed. Using the heading change and the longitudinal acceleration, the improved navigation system propagates a previous position to a current position. The third accelerometer provides pitch to assist in calibrating the other accelerometers or other sensors and in altering the longitudinal and/or lateral acceleration information.

In an embodiment of the present technology, as was stated above, the motion detector 14 of FIG. 1 can be used for mobile navigation of the apparatus 10 if the GNSS navigation processor obtains fixes are not verified. Please, see the discussion below. However, the absolute location of the apparatus 10 of FIG. 1 cannot be obtained by using only the motion detector 14 of FIG. 1.

In an embodiment of the present technology, the triangulation correlation processor 26 of FIG. 1 is configured to perform the task of obtaining the absolute location of the apparatus 10.

Mobile positioning, which includes location based service that discloses the actual coordinates of a mobile phone bearer, is a technology used by telecommunication companies to approximate where a mobile phone, and thereby also its user (bearer), temporarily resides. The more properly applied term locating refers to the purpose rather than a positioning process. Such service is offered as an option of the class of location-based services (LBS).

Mobile phone tracking refers to the attaining of the current position of a mobile phone, stationary or moving. Localization may occur either via triangulation of radio signals between (several) radio towers of the network and the phone. To locate the smart phone using triangulation of radio signals, it must emit at least the roaming signal to contact the next nearby antenna tower, but the process does not require an active call. GSM is based on the signal strength to nearby antenna masts.

The technology of locating is based on measuring power levels and antenna patterns and uses the concept that a powered mobile phone always communicates wirelessly with one of the closest base stations, so knowledge of the location of the base station implies the cell phone is nearby.

Advanced systems determine the sector in which the mobile phone resides and roughly estimate also the distance to the base station. Further approximation can be done by interpolating signals between adjacent antenna towers. Qualified services may achieve a precision of down to 50 meters in urban areas where mobile traffic and density of antenna towers (base stations) is sufficiently high. Rural and desolate areas may see miles between base stations and therefore determine locations less precisely.

GSM localization is the use of triangulation to determine the location of GSM mobile phones, or dedicated trackers, usually with the intent to locate the user. Localization-Based Systems can be broadly divided into: (i) network-based; (ii) handset-based; and (iii) SIM-based.

In order to route calls to a phone, the cell towers listen for a signal sent from the phone and negotiate which tower is best able to communicate with the phone. As the phone changes location, the antenna towers monitor the signal, and the phone is roamed to an adjacent tower as appropriate. By comparing the relative signal strength from multiple antenna towers, a general location of a phone can be roughly determined. Other means make use of the antenna pattern, which supports angular determination and phase discrimination.

In an embodiment of the present technology, the triangulation correlation processor 26 of FIG. 1 is configured to perform the task of obtaining the absolute location of the apparatus 10 by using the network-based techniques. In this embodiment, the service provider's network infrastructure is utilized to identify the location of the apparatus 10 by locating the handset of the smartphone. The advantage of network-based techniques (from a mobile operator's point of view) is that they can be implemented non-intrusively, without affecting the handsets.

The accuracy of network-based techniques varies, with cell identification as the least accurate and triangulation as moderately accurate, and newer “Forward Link” timing methods as the most accurate. The accuracy of network-based techniques is both dependent on the concentration of base station cells, with urban environments achieving the highest possible accuracy, and the implementation of the most current timing methods.

One of the key challenges of network-based techniques is the requirement to work closely with the service provider, as it entails the installation of hardware and software within the operator's infrastructure. Often, a legislative framework, such as E911, would need to be in place to compel the cooperation of the service provider as well as to safeguard the privacy of the information.

In an embodiment of the present technology, the triangulation correlation processor 26 of FIG. 1 is configured to perform the task of obtaining the absolute location of the apparatus 10 by using handset-based technology. In this embodiment, the installation of client software on the handset is required to determine its location. This technique determines the location of the handset by computing its location by cell identification, signal strengths of the home and neighboring cells, which is continuously sent to the carrier. In addition, if the handset is also equipped with GPS then significantly more precise location information is then sent from the handset to the carrier.

The key disadvantage of this technique (from mobile operator's point of view) is the necessity of installing software on the handset. It requires the active cooperation of the mobile subscriber as well as software that must be able to handle the different operating systems of the handsets. Typically, smartphones, such as one based on Symbian, Windows Mobile, Windows Phone, BlackBerry OS, iPhone, or Android, would be able to run such software.

In an embodiment of the present technology, the triangulation correlation processor 26 of FIG. 1 is configured to perform the task of obtaining the absolute location of the apparatus 10 by using the SIM in GSM and UMTS handsets. In this embodiment, it is possible to obtain raw radio measurements from the handset. The measurements that are available can include the serving Cell ID, round trip time and signal strength. The type of information obtained via the SIM can differ from what is available from the handset. For example, it may not be possible to obtain any raw measurements from the handset directly, yet still obtain measurements via the SIM

Locating or positioning touches upon delicate privacy issues, since it enables someone to check where a person is without the person's consent. Strict ethics and security measures are strongly recommended for services that employ positioning, and the user must give an informed, explicit consent to a service provider before the service provider can compute positioning data from the user's mobile phone.

In Europe, where most countries have a constitutional guarantee on the secrecy of correspondence, location data obtained from mobile phone networks is usually given the same protection as the communication itself. The United States, however, has no explicit constitutional guarantee on the privacy of telecommunications, so use of location data is limited by law.

The Electronic Frontier Foundation is tracking some cases, including USA v. Pen Register, regarding government tracking of individuals. In the US, an interpretation of The Patriot Act that is secret, but confirmed to exist, has been linked to secret widespread location tracking.

China has proposed using this technology to track commuting patterns of Beijing city residents. Aggregate presence of mobile phone users could be tracked in a privacy-preserving fashion.

Referring still to FIG. 1, in an embodiment of the present technology, as was discussed above, the motion detector 14 aided by triangulation correlation processor 26 is configured to obtain a set of motion-related data associated with the apparatus 10 including the acceleration, velocity, and absolute location.

Referring still to FIG. 1, in an embodiment of the present technology, the set of motion-related data comprises at least two sets of motion-related data associated with the apparatus 10 including the acceleration, velocity, and absolute location data elements taken at substantially the same consecutive time points t(i) and t(j). This data can also be used to corroborate the accuracy of the position fix of the GNSS processor 20.

In an embodiment of the present technology, at least one time interval includes a single GPS Epoch.

In an embodiment of the present technology, referring still to FIG. 1, the correlation processor 26 is configured to correlate the set of position fixes associated with the smart phone with the set of motion-related data associated with the smart phone and configured to obtain a set of correlation data.

In an embodiment of the present technology, the correlation processor 26 implements the correlation algorithm (not shown) configured to correlate the set of GNSS-based acceleration magnitude data associated with the smart phone with the set of acceleration magnitude data of the smart phone obtained by the motion detector 14 for at least one time interval.

In an embodiment of the present technology, the correlation algorithm comprises the following steps: (a) if a GNSS-based acceleration magnitude of the smart phone exceeds the motion detector-based acceleration magnitude of the smart phone by a predetermined threshold at at least one time interval, the GNSS position fix is marked as a suspect GNSS position fix; and the corresponding time interval is marked as a suspect time interval; and (b) the set of GNSS correlation data is obtained by adding each suspect GNSS readings at each suspect time interval into a set of suspect GNSS readings.

In an embodiment of the present technology, referring still to FIG. 1, wherein the apparatus 10 further comprises the verified location display 12, the correlation processor 26 is further configured to identify the set of suspect GNSS position fixes while displaying position fixes of the smart phone on the verified location display 12.

In an embodiment of the present technology, referring still to FIG. 1, wherein the apparatus 10 further comprises the verified location display 12, the correlation processor 26 is further configured to implement to assign a degradation grade to each suspect GNSS position fixes while displaying position fixes of the smart phone on the verified location display 12.

In an embodiment of the present technology, each degradation grade is defined by the degree of deviation between the suspect acceleration data and the motion detector-based acceleration data.

In an embodiment of the present technology, referring still to FIG. 1, wherein the apparatus 10 further comprises the verified location display 12, the correlation processor 26 is further configured to implement the next step of the correlation algorithm and to select the degradation grade from the group consisting from: a star next to a data point in the verified location display 12; a mark in a data record being stored in non-volatile memory (not shown) as part of its normal operation; and an audible sound actuated upon detection of the suspect correlation data. The audible sound actuated upon detection of the suspect correlation data is stored in both volatile memory (not shown) and non-volatile memory (not shown). The set of suspect acceleration data is stored in the memory 16.

In an embodiment of the present technology, referring still to FIG. 1, wherein the apparatus 10 further comprises the verified location display 12, the correlation processor 26 is further configured to implement the next step of the correlation algorithm and to downgrade the set of suspect GNSS readings while computing actual position coordinates of the smart phone. The set of downgraded acceleration data is stored in the memory 16.

In an embodiment of the present technology, referring still to FIG. 1, wherein the apparatus 10 further comprises the verified location display 12, the correlation processor 26 is further configured to implement the next step of the correlation algorithm and to assign a relative quality metric for each suspect position fix data based on a predetermined set of error thresholds. The set of predetermined error thresholds is stored in both volatile memory (not shown) and non-volatile memory (not shown). The relative quality metric is stored in both volatile memory (not shown) and non-volatile memory (not shown). The set of suspect acceleration data is stored in the memory 16.

In an embodiment of the present technology, referring still to FIG. 1, wherein the apparatus 10 further comprises the verified location display 12, the correlation processor 26 is further configured to implement the next step of the correlation algorithm and to create a hierarchy of position fix quality, wherein each suspect GNSS readings is placed in the hierarchy of position fix quality based on its grade. The hierarchy of position fix quality based on its grade is stored in the memory 16.

In an embodiment of the present technology, referring still to FIG. 1, wherein the apparatus 10 further comprises the verified location display 12, the correlation processor 26 is further configured to implement the next step of the correlation algorithm and to assign a low weight to each suspect GNSS reading while computing actual position coordinates of the smart phone.

### Example 1

### Handheld Data Collector

A very low cost accelerometer is combined with a GPS in a handheld data collector. When using the GPS to measure velocity or position, compare the GPS-derived acceleration magnitude with the acceleration magnitude reading from the accelerometer.

### Example 2

### GPS for Agricultural Applications (AGPS)

For each new GPS reading (based on time and distance apparently moved from the last reading) make comparison with the magnitude of the accelerometer reading, during the same time period. (Note: the direction of the accelerometer reading is unimportant.) If GPS-derived acceleration reading is greater than the accelerometer-derived reading, the GPS-derived acceleration reading can be marked as suspect and given less weight when computing the actual position/velocity of the user based on the trend from a string of readings. Further, the weight given to the reading can be attenuated in a ratio to the amount that GPS-derived acceleration reading exceeds the accelerometer-derived reading. This procedure allows an “intelligent smoothing” rather than a least squares fit when calculating position and velocity of the smart phone thus improving accuracy and speed of measurements.

### Example 3

### Identification of Multipath Spikes

The comparison between the motion detector-based measurements and GPS-derived measurements is preferably performed in the measurement domain, rather than after position/velocity has been calculated. That way the multipath spikes can be identified on certain SVs and exclude them from the position solution.

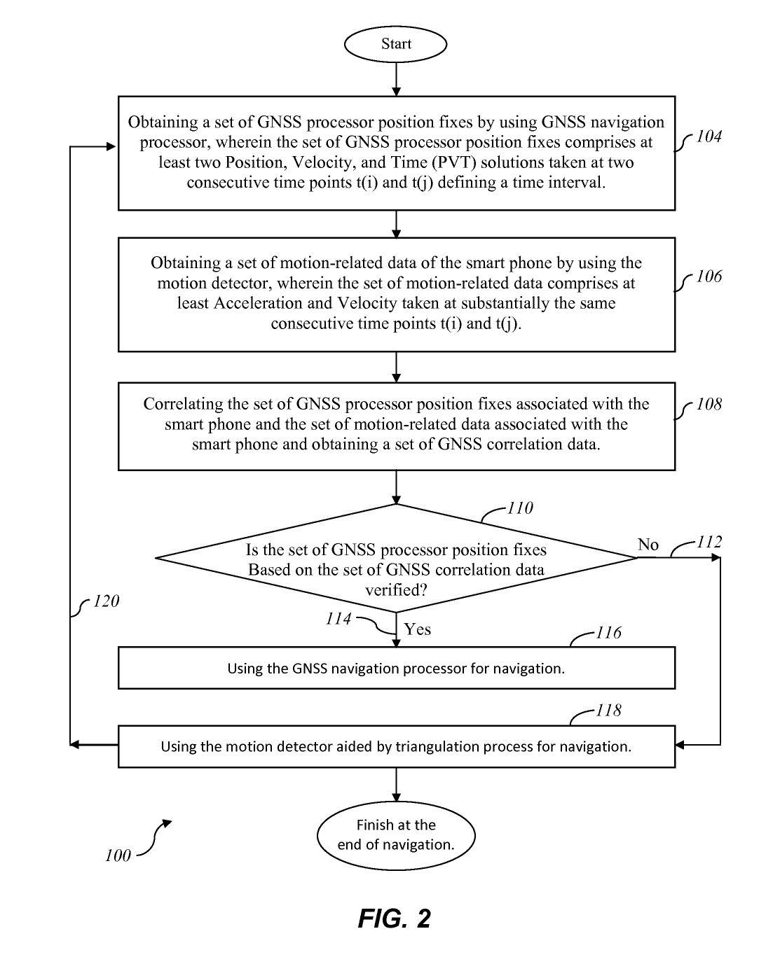

In an embodiment of the present technology, FIG. 2 illustrates the flow diagram 100 of the method of mobile navigation of the present technology using the apparatus 10 of FIG. 1.

In an embodiment of the present technology, at the step 104 of the flow chart 100 of FIG. 2, the GNSS navigation processor 20 (of FIG. 1) obtains a set of GNSS processor position fixes; wherein the set of GNSS processor position fixes comprises at least two Position, Velocity, and Time (PVT) solutions taken at two consecutive time points t(i) and t(j) defining a time interval. The acceleration can be calculated by using the velocity fixes at two consecutive time points t(i) and t(j) defining a time interval.

In an embodiment of the present technology, at the next step 106 of the flow chart 100 of FIG. 2, the motion detector 14 aided by the triangulation processor 18 is configured to obtain a set of motion-related data of the smart phone by using the set of motion-related data comprises at least Acceleration and Velocity taken at two consecutive time points t(i) and t(j), and absolute position of the smart phone.

In an embodiment of the present technology, at the next step 108 of the flow chart 100 of FIG. 2, the correlation processor 26 is configured to correlate the set of GNSS processor position fixes associated with the smart phone obtained in the step 104 and the set of motion-related data associated with said smart phone obtained at the step 106, and is configured to obtain a set of GNSS correlation data.

In an embodiment of the present technology, if the condition 110 is satisfied (logical arrow 114), that is if the set of GNSS processor position fixes based on the set of GNSS correlation data is verified, the GNSS navigation processor 20 can be used for navigation (step 116).

In an embodiment of the present technology, if the condition 110 is not satisfied (logical arrow 112), that is if the set of GNSS processor position fixes based on the set of GNSS correlation data is not verified, the motion detector 14 aided by a triangulation processor 18 can be used for navigation (step 118). Preferably, the steps 104-118 are repeated (step 120) for the duration of the smart phone navigation.

The above discussion has set forth the operation of various exemplary systems and devices, as well as various embodiments pertaining to exemplary methods of operating such systems and devices. In various embodiments, one or more steps of a method of implementation are carried out by a processor under the control of computer-readable and computer-executable instructions. Thus, in some embodiments, these methods are implemented via a computer.

In an embodiment, the computer-readable and computer-executable instructions may reside on computer useable/readable media.

Therefore, one or more operations of various embodiments may be controlled or implemented using computer-executable instructions, such as program modules, being executed by a computer. Generally, program modules include routines, programs, objects, components, data structures, etc., that perform particular tasks or implement particular abstract data types. In addition, the present technology may also be practiced in distributed computing environments where tasks are performed by remote processing devices that are linked through a communications network. In a distributed computing environment, program modules may be located in both local and remote computer-storage media including memory-storage devices.

Although specific steps of exemplary methods of implementation are disclosed herein, these steps are examples of steps that may be performed in accordance with various exemplary embodiments. That is, embodiments disclosed herein are well suited to performing various other steps or variations of the steps recited. Moreover, the steps disclosed herein may be performed in an order different than presented, and not all of the steps are necessarily performed in a particular embodiment.

Although various electronic and software based systems are discussed herein, these systems are merely examples of environments that might be utilized, and are not intended to suggest any limitation as to the scope of use or functionality of the present technology. Neither should such systems be interpreted as having any dependency or relation to any one or combination of components or functions illustrated in the disclosed examples.

Although the subject matter has been described in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method for mobile navigation by using a smart phone; said smart phone comprising: a GNSS navigation processor, a motion detector, a correlation processor, a triangulation processor, and a verified location display; said method comprising:
(A) obtaining a set of GNSS processor position fixes by using said GNSS navigation processor; wherein said set of GNSS processor position fixes comprises at least two Position, Velocity, and Time (PVT) solutions taken at two consecutive time points t(i) and t(j) defining a time interval;
(B) obtaining a set of motion-related data of said smart phone by using said motion detector; wherein said set of motion-related data comprises at least Acceleration and Velocity taken at two consecutive time points t(i) and t(j);
(C) correlating said set of GNSS processor position fixes associated with said smart phone and said set of motion-related data associated with said smart phone and obtaining a set of GNSS correlation data;
(D) if said set of GNSS processor position fixes based on said set of GNSS correlation data is verified, using said GNSS navigation processor for navigation;
(E) if said set of GNSS processor position fixes based on said set of GNSS correlation data is not verified, using said motion detector aided by a triangulation processor for navigation;
and
(F) repeating said steps (A)-(E) for the duration of said smart phone navigation.

2. The method of claim 1, wherein said step (A) further comprises:
(A1) selecting said smart phone from the group consisting of: a Blackberry; an Android; an iPhone; an iPhone 3GS, an iPhone 4, an iPhone 4S; an iPhone 5; an iPad; a fourth generation iPad; and iPad mini.

3. The method of claim 1, wherein said step (A) further comprises:
(A2) selecting said GNSS processor from the group consisting of: GPS processor; GLONASS processor; combined GPS/GLONASS processor; COMPASS processor; and GALILEO processor.

4. The method of claim 1, wherein said step (B) further comprises:
(B1) selecting said motion detector from the group consisting of: an accelerometer; at least three accelerometers; and at least six accelerometers.

5. The method of claim 1, wherein said step (B) further comprises:
(B2) obtaining an acceleration magnitude and a velocity magnitude of said smart phone by using said motion detector aided by triangulation processor; said motion detector including at least one accelerometer.

6. The method of claim 5, wherein said step (B2) further comprises:
(B2, 1) obtaining an absolute location of said smart phone via triangulation of radio signals between at least three radio towers of the network and said smart phone.

7. The method of claim 1, wherein said step (B) further comprises:
(B3) obtaining components of an acceleration vector in the x, y, and z-axes of a Cartesian coordinate system and components of velocity vector in the x, y, and z-axes of a Cartesian coordinate system of said smart phone by using said mobile detector aided by triangulation processor; said motion detector including at least three accelerometers.

8. The method of claim 7, wherein said step (B3) further comprises:
(B3, 1) obtaining an absolute location of said smart phone via triangulation of radio signals between at least three radio towers of the network and said smart phone.

9. The method of claim 1, wherein said step (B) further comprises:
(B4) obtaining components of an acceleration vector in the x, y, and z-axes of a Cartesian coordinate system and three additional accelerations corresponding to pitch, roll, and rotation in the x, y, and z-axes of a Cartesian coordinate system, and components of velocity vector in the x, y, and z-axes of a Cartesian coordinate system by using said mobile detector aided by triangulation processor; said motion detector including at least six accelerometers.

10. The method of claim 9, wherein said step (B4) further comprises:
(B4, 1) obtaining an absolute location of said smart phone via triangulation of radio signals between at least three radio towers of the network and said smart phone.

11. The method of claim 1, wherein said step (C) further comprises:
(C1) correlating a set of GNSS-based acceleration magnitude data of said smart phone with a set of acceleration magnitude data of said smart phone obtained by said motion detector for at least one said time interval;
(C2) if a GNSS-based acceleration magnitude of said smart phone exceeds said motion detector-based acceleration magnitude of said smart phone by a predetermined threshold at at least one said time interval, marking said GNSS position fix as a suspect GNSS position fix; and marking said at least one time interval as a suspect time interval;
and
(C3) obtaining said set of GNSS correlation data by adding each said suspect GNSS readings at each said suspect time interval into a set of suspect GNSS readings.

12. The method of claim 1, wherein said step (D) further comprises:
(D1) identifying said set of suspect GNSS position fixes while displaying position fixes of said smart phone.

13. The method of claim 10, wherein said step (D1) further comprising:
(D1, 1) assigning a degradation grade to each said suspect GNSS position fixes while displaying position fixes of said smart phone; wherein each said degradation grade is defined by the degree of deviation between said suspect acceleration data and said motion detector-based acceleration data.

14. The method of claim 14, wherein said step (D1, 1) further comprising:
(D1, 1, 1) selecting said degradation grade from the group consisting from:
a star next to a data point in said visual display; a mark in a data record being stored by the rest of said smart phone as part of its normal operation; and an audible sound actuated upon detection of said suspect correlation data.

15. The method of claim 1, wherein said step (E) further comprises:
(E1) if said set of suspect GNSS readings is degraded below a predetermined grade level, using said motion detector for smart phone navigation.

16. An apparatus for mobile navigation by using a smart phone comprising:
(A) a means for obtaining a set of GNSS processor position fixes;
(B) a means for obtaining a set of motion-related data of said smart phone; and
(C) a means for correlating said set of GNSS processor position fixes associated with said smart phone and said set of motion-related data associated with said smart phone and for obtaining a set of GNSS correlation data;
wherein said set of GNSS processor position fixes is used for navigation if said set of GNSS processor position fixes based on said set of GNSS correlation data is verified;
and wherein said set of motion-related data is used for navigation if said set of GNSS processor position fixes based on said set of GNSS correlation data is not verified.

17. The apparatus of claim 16, wherein said means (A) further comprises:
(A1) said smart phone selected from the group consisting of:
a Blackberry; an Android; an iPhone; an iPhone 3GS, an iPhone 4, an iPhone 4S; an iPhone 5; an iPad; a fourth generation iPad; and iPad mini.

18. The apparatus of claim 16, wherein said means (A) further comprises:
(A2) a GNSS processor selected from the group consisting of:
GPS processor; GLONASS processor; combined GPS/GLONASS processor; COMPASS processor; and GALILEO processor.

19. The apparatus of claim 16, wherein said means (B) further comprises:
(B1) a motion detector selected from the group consisting of:
an accelerometer; at least three accelerometers; and at least six accelerometers.

20. The apparatus of claim 16, wherein said means (B) further comprises:
(B2) a triangulation processor configured to obtain an absolute location of said smart phone by using at least three radio signals transmitted from at least three radio towers of the network to said smart phone.

21. The apparatus of claim 16, wherein said means (C) further comprises:
(C1) a correlator processor configured to correlate a set of GNSS-based acceleration magnitude data of said smart phone with a set of acceleration magnitude data of said smart phone obtained by said motion detector for at least one said time interval; wherein if a GNSS-based acceleration magnitude of said smart phone exceeds said motion detector-based acceleration magnitude of said smart phone by a predetermined threshold at at least one said time interval, said correlator processor is configured to mark said GNSS position fix as a suspect GNSS position fix; and is configured to mark said at least one time interval as a suspect time interval.

22. The apparatus of claim 16 further comprising:
(D) a verified location display configured to display verified position fixes of said smart phone.

23. The apparatus of claim 2, wherein said verified location display (D) further comprises:
(D1) a verified location display configured to display said degradation grade selected from the group consisting from:
a star next to a data point in said visual display; a mark in a data record being stored by the rest of said smart phone as part of its normal operation; and an audible sound actuated upon detection of said suspect correlation data.

24. A non-transitory computer-readable storage medium useful in association with an apparatus for mobile navigation by using a smart phone; said smart phone comprising: a GNSS navigation processor, a motion detector, a correlation processor, a triangulation processor, and a verified location display; said non-transitory computer-readable storage medium including computer-readable code instructions configured to cause said processor to execute the steps of
(A) obtaining a set of GNSS processor position fixes by using said GNSS navigation processor; wherein said set of GNSS processor position fixes comprises at least two Position, Velocity, and Time (PVT) solutions taken at two consecutive time points t(i) and t(j) defining a time interval;
(B) obtaining a set of motion-related data of said smart phone by using said motion detector; wherein said set of motion-related data comprises at least Acceleration and Velocity taken at two consecutive time points t(i) and t(j);
(C) correlating said set of GNSS processor position fixes associated with said smart phone and said set of motion-related data associated with said smart phone and obtaining a set of GNSS correlation data;
(D) if said set of GNSS processor position fixes based on said set of GNSS correlation data is verified, using said GNSS navigation processor for navigation;
(E) if said set of GNSS processor position fixes based on said set of GNSS correlation data is not verified, using said motion detector aided by a triangulation processor for navigation;
and
(F) repeating said steps (A)-(E) for the duration of said smart phone navigation.

25. A computer program product that includes a non-transitory computer-readable medium having a sequence of instructions which, when executed by a processor, causes the processor to execute a process for providing mobile navigation by using a smart phone; said smart phone comprising: a GNSS navigation processor, a motion detector, a correlation processor, a triangulation processor, and a verified location display; the process comprising:
(A) obtaining a set of GNSS processor position fixes by using said GNSS navigation processor; wherein said set of GNSS processor position fixes comprises at least two Position, Velocity, and Time (PVT) solutions taken at two consecutive time points t(i) and t(j) defining a time interval;
(B) obtaining a set of motion-related data of said smart phone by using said motion detector; wherein said set of motion-related data comprises at least Acceleration and Velocity taken at two consecutive time points t(i) and t(j);
(C) correlating said set of GNSS processor position fixes associated with said smart phone and said set of motion-related data associated with said smart phone and obtaining a set of GNSS correlation data;
(D) if said set of GNSS processor position fixes based on said set of GNSS correlation data is verified, using said GNSS navigation processor for navigation;
(E) if said set of GNSS processor position fixes based on said set of GNSS correlation data is not verified, using said motion detector aided by a triangulation processor for navigation;
and
(F) repeating said steps (A)-(E) for the duration of said smart phone navigation.
